(19) United States
(12) Patent Application Publication
(10) Pub. No.: US 2014/0244992 A1
(43) Pub. Date: Aug. 28, 2014

(54) Extensible Firmware Interface External Graphic Card, Mainframe System, and Extensible Firmware Interface BIOS Booting Method

(71) Applicant: Silicon Motion Inc., Hsinchu County (TW)

(72) Inventor: Hao Wang, Shanghai (CN)

(73) Assignee: Silicon Motion Inc., Hsinchu County (TW)

(21) Appl. No.: 14/191,447

(22) Filed: Feb. 27, 2014

(30) Foreign Application Priority Data
Feb. 28, 2013 (CN) 201310066020.4

(51) Int. Cl. G06F 9/44

(52) U.S. Cl. CPC G06F 9/4411
USPC 713/2

(57) ABSTRACT

A central processing unit of a mainframe system is configured to load a physical graphic card driver into a memory of the mainframe system for performing a display function when the mainframe system is not connected to an Extensible Firmware Interface (EFI) external graphic card. The central processing unit is further configured to load a virtual graphic card driver into the memory of the mainframe system for performing the display function when the mainframe system is connected to the EFI external display card.

### BACKGROUND OF THE INVENTION

1. Field of the Invention

The present invention discloses an extensible firmware interface (EFI) external graphic card, a mainframe system, and a booting method of an EFI BIOS system, and more particularly, an EFI external graphic card implemented using the EFI standards, a mainframe system operated in cooperation with the EFI external graphic card, and a booting method applied on the EFI external graphic card and an EFI BIOS system of the mainframe system.

2. Description of the Prior Art

In a conventional desktop computer or a notebook computer, a graphic card is configured for implementing a display function, where an interface between the graphic card and the conventional computers may be supported by the accelerated graphics port (AGP) standards, the personal computer interconnect (PCI) standards, or the personal computer interconnect express (PCIe) standards.

Under a boot procedure of a conventional computer, a basic output/input system (BIOS) stored on firmware of the conventional computer is loaded to a memory, so that a central processing unit (CPU) of the conventional computer is capable of reading and executing the BIOS to execute most primary functions of the conventional computer, where the primary functions includes a driving function of the graphic card. Therefore, the graphic card may be driven via the abovementioned interface to execute the display function of the graphic card after the conventional computer is booted.

### SUMMARY OF THE INVENTION

The claimed invention discloses an extensible firmware interface (EFI) external graphic card. The EFI external graphic card comprises a graphic processing unit (GPU), an EFI graphic card driving module, a connection port, and a control module. The EFI graphic card driving module is configured to store an EFI graphic card driver. The control module is configured to enable an EFI Basic I/O System (BIOS) system to drive the EFI graphic card driving module when the connection port is connected to the EFI BIOS mainframe system, for loading the EFI graphic card driver from the EFI graphic card driving module to the EFI BIOS mainframe system.

The claimed invention discloses a mainframe system. The mainframe system comprises a central processing unit (CPU), a first memory coupled to the CPU; and an EFI BIOS system. The EFI BIOS system comprises a second memory configured to store a virtual graphic card driver. The CPU is configured to determine whether the mainframe system is connected to a physical graphic unit in a first boot procedure of the mainframe system. The EFI BIOS system is configured to execute the virtual graphic card driver in a DXE stage of the first boot procedure for mounting the virtual graphic card driver on the first memory when the CPU determines that the mainframe system is not connected to a physical graphic unit. The CPU is configured to render the physical graphic unit to execute a physical graphic driver built-in in the physical graphic unit in the DXE stage of the first boot procedure for mounting the physical graphic driver on the first memory when the CPU determines that the mainframe system is connected to the physical graphic unit.

The claimed invention discloses a booting method of an EFI BIOS system. The booting method comprises determining whether a mainframe system is connected to a physical graphic unit; executing a virtual graphic card driver stored in the EFI BIOS system included by the mainframe system for mounting the virtual graphic card driver on a first memory of the mainframe system when the mainframe system is determined to not be connected to a physical graphic unit; and driving the physical graphic unit for mounting a physical graphic driver stored in the physical graphic unit on the first memory when the mainframe system is determined to be connected to the physical graphic unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of an EFI external graphic card according to one embodiment of the present invention.

FIG. 2 illustrates a mainframe system according to one embodiment of the present invention.

FIG. 3 illustrates a block diagram of a display system according to one embodiment of the present invention.

FIG. 4 illustrates a flowchart of the booting method according to one embodiment of the present invention.

### DETAILED DESCRIPTION

The present invention discloses an EFI external graphic card storing a virtual graphic card driver and a mainframe system having an EFI BIOS system. With the aid of the disclosed EFI external graphic card and the disclosed mainframe system, the EFI BIOS system may still be utilized for executing the virtual graphic card to perform the display function when the mainframe system is not connected to the EFI external graphic card, or the EFI external graphic card may execute its built-in physical graphic card driver for performing the display function when the mainframe system is connected to the EFI external graphic card. The virtual graphic card driver and the physical graphic card driver can both be supported by the EFI standards.

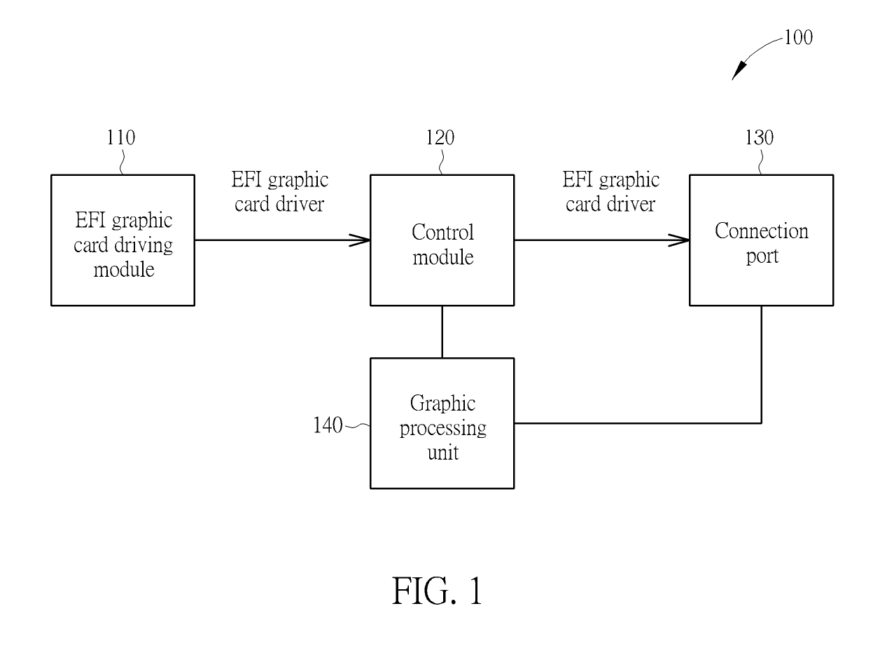

Please refer to FIG. 1, which illustrates a block diagram of an EFI external graphic card 100 according to one embodiment of the present invention. The EFI external graphic card 100 includes an EFI graphic card driving module 110, a control module 120, a connection port 130, and a graphic processing unit (GPU) 140.

The EFI graphic card driving module 110 is configured to store an EFI graphic card driver, which is also a physical graphic card driver and is supported by the EFI standards.

The connection port 130 is utilized as a bridge between the EFI external graphic card 100 and other external computers for data transmission. In some embodiments of the present invention, the connection port 130 may be a universal serial bus (USB) port or an Ethernet port.

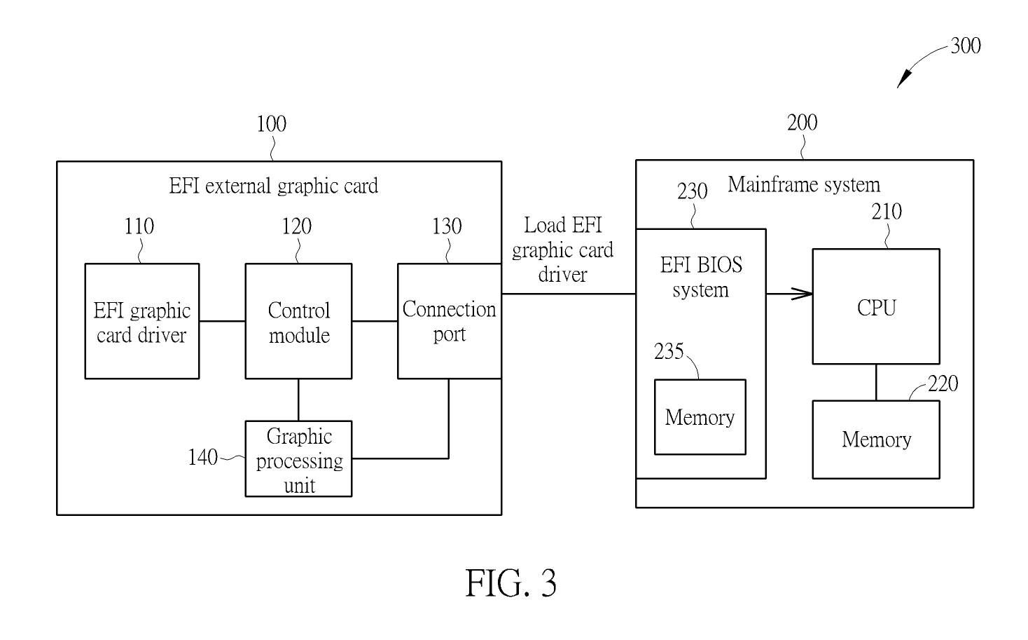

The control module 120 is coupled to the EFI graphic card driving module 110, the GPU 140, and the connection port 130. The control module 120 is primarily configured to enable a mainframe system to drive the EFI graphic card driving module 110 when the connection port 130 is connected to the mainframe system, so as to load the EFI graphic card driver to the mainframe system to perform the display function. Interactions between the control module 120 and the mainframe system 100 will be described later according to a condition shown in FIG. 3 that the EFI eternal graphic card 100 has been connected to the mainframe system.

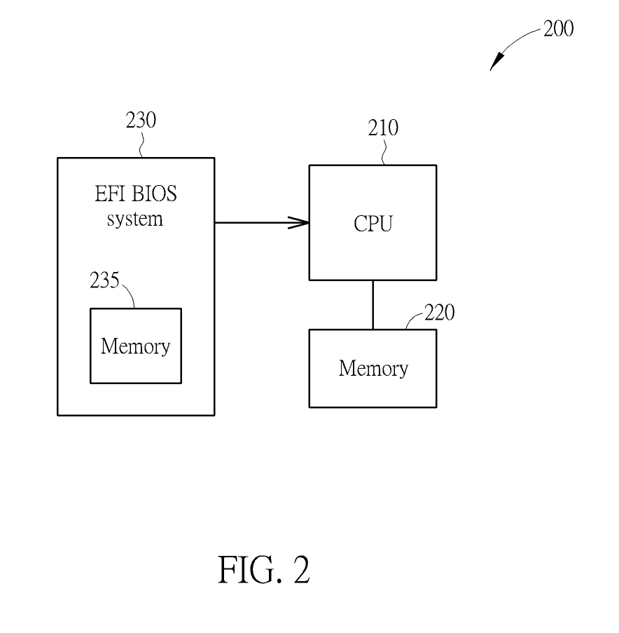

Please refer to FIG. 2, which illustrates a mainframe system 200 according to one embodiment of the present invention. As shown in FIG. 2, the mainframe system 200 includes a CPU 210, a memory 220, and an EFI BIOS system 230 which includes a memory 235. The memory 235 is configured to store a virtual graphic card driver.

The CPU 210 is coupled to the memory 220 and the EFI BIOS system 230. The CPU 210 is configured to determine whether the mainframe system 200 is connected to a physical graphic unit via the EFI BIOS system 230 during a boot procedure of the mainframe system 200. In one embodiment of the present invention, the physical graphic unit may be the EFI graphic card driving module 100 shown in FIG. 1.

When the CPU 210 determines that the mainframe 200 is not connected to a physical graphic unit, during a driver execution environment (DXE) stage) of the boot procedure of the mainframe 200, the EFI BIOS system 230 is configured to execute the virtual graphic card driver stored by the memory 235 for mounting the virtual graphic card driver on the memory 220 via the CPU 210.

The virtual graphic card driver is supported by the EFI standards, and is utilized for supporting a display function independent from the mainframe system using a graphics output protocol (GOP), that is, the display function of the mainframe system 200 can be directly driven under the condition that the mainframe system 200 is not connected to a physical graphic unit. Therefore, the mainframe system 200 is free from hardware cost introduced by a graphic card and a bus corresponding to the graphic card; for example, the hardware cost may be additionally introduced because of utilizing the AGP standards, the PCI standards, and the PCIe standards utilized in the prior art.

When the CPU 210 determines that the mainframe system 200 is connected to a physical graphic unit, under the abovementioned DXE stage, the CPU 210 renders the physical graphic unit to execute its built-in physical graphic card driver, e.g., the built-in EFI graphic card driver of the EFI graphic card driving module 110 shown in FIG. 1, for the purpose of mounting he EFI graphic card driver on the memory 220 via the CPU 210.

Please refer to FIG. 3, which illustrates a block diagram of a display system 300 according to one embodiment of the present invention.

As shown in FIG. 3, the display system 300 includes the EFI external graphic card 100 shown in FIG. 1 and the mainframe system 200 shown in FIG. 2, where the EFI external graphic card 100 has been connected to the mainframe system 200 via the connection port 130. At this time, the CPU 210 is connected to the EFI external graphic card 100 via the connection port 130.

As described in the abovementioned descriptions related to FIG. 1 and FIG. 2, the control module 120 is configured to load the EFI graphic card driver from the EFI graphic card driving module 110 when the connection port 130 is connected to the mainframe system 200 and when the mainframe system 200 enters the DXE stage; the control module 120 is further configured to mount the EFI graphic card driver on the memory 220 of the mainframe system 200 via the connection port 130 for driving the graphic card using the EFI standards or is further configured to load a USB device driver to the memory 220 via the connection port 130 for rendering the mainframe system 200 to perform the display function using the EFI standards.

Some architecture-specific applications supported by the EFI standards provide interfaces that can be utilized by an operating system. Therefore, after the operating system loads the architecture-specific applications, said operating system is capable of directly driving a graphic card of a mainframe system installing the operating system to perform a basic display function of the graphic card without loading the BIOS program codes from firmware. As a result, the EFI graphic card driver is capable of performing the display function on the mainframe system 200 under a condition that the operating system of the mainframe system 200 has not loaded the BIOS program codes.

Besides, in one embodiment of the present invention, since an EFI boot loader supported by the EFI standards is stored in the memory 235 in advance, under the condition that the control module 120 confirms that the EFI external graphic card 100 has been connected to the mainframe system 200 shown in FIG. 3, the mainframe system 200 is configured to directly execute the EFI boot loader on the EFI BIOS system 230 for enabling the mainframe system 200 to initiate its booting procedure.

In one embodiment of the present invention, the connection port 130 may be a wired USB port, a wireless USB port, or an Internet Protocol (IP) USB port, so that the control module 120 is capable of load the EFI graphic card driver to the memory 220 for performing the display function on the mainframe system 200.

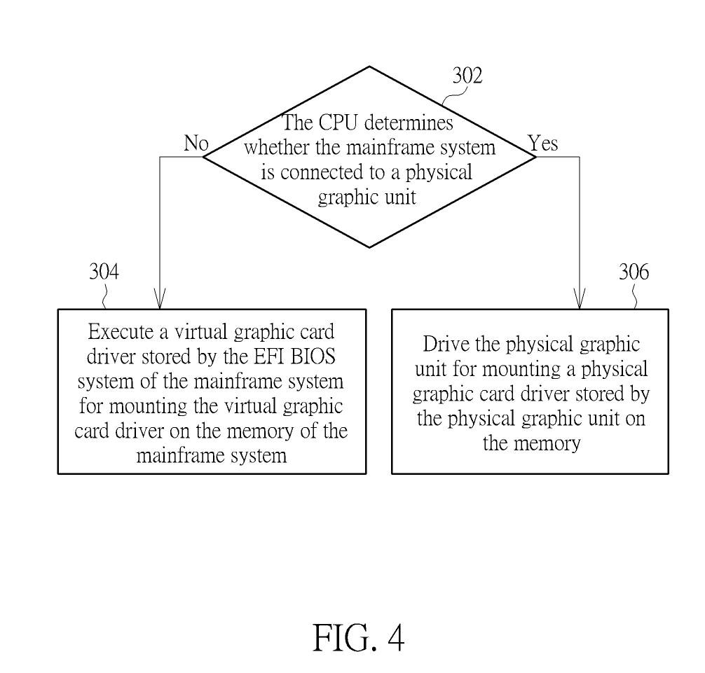

Please refer to FIG. 4, which illustrates a flowchart of the booting method according to one embodiment of the present invention. As shown in FIG. 4, the booting method includes the following steps:

Step 302: The CPU 210 determines whether the mainframe system 200 is connected to a physical graphic unit; when the CPU 210 confirms that the mainframe system 200 is not connected to a physical graphic unit, go to Step 304; else, go to Step 306.

Step 304: Execute a virtual graphic card driver stored by the EFI BIOS system 230 of the mainframe system 200, for mounting the virtual graphic card driver on the memory 220 of the mainframe system 200.

Step 306: Drive the physical graphic unit for mounting a physical graphic card driver stored by the physical graphic unit on the memory 220.

Note that embodiments formed by adding any abovementioned limitations and/or by adding reasonable combinations/permutations to steps shown in FIG. 4 should also be regarded as embodiments of the present invention.

The present invention discloses an EFI external graphic card supported by the EFI standards, a mainframe system run in cooperation with the EFI external graphic card, and a booting method applied an EFI BIOS system of the mainframe system and the EFI external graphic card. With the aid of the disclosed EFI external graphic card, the disclosed mainframe system, and the disclosed booting method, a graphic card can be driven without loading BIOS program codes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An extensible firmware interface (EFI) external graphic card, comprising:
a graphic processing unit (GPU);
an EFI graphic card driving module, configured to store an EFI graphic card driver;
a connection port; and
a control module, configured to enable an EFI Basic I/O System (BIOS) mainframe system to drive the EFI graphic card driving module when the connection port is connected to the EFI BIOS mainframe system, for loading the EFI graphic card driver from the EFI graphic card driving module to the EFI BIOS mainframe.

2. The EFI external graphic card of claim 1, wherein the control module is further configured to load the EFI graphic card driver into the EFI BIOS mainframe system during a driver execution environment (DXE) stage of the EFI BIOS mainframe system.

3. The EFI external graphic card of claim 2, wherein the EFI BIOS mainframe system is configured to drive the GPU using the EFI graphic card driver loaded into the EFI BIOS mainframe system.

4. The EFI external graphic card of claim 1, wherein the connection port is a wired USB port, a wireless USB port, or an Internet Protocol (IP) USB port.

5. A mainframe system, comprising:
a central processing unit (CPU);
a first memory, coupled to the CPU; and
an EFI BIOS system, comprising:
a second memory, configured to store a virtual graphic card driver;
wherein the CPU is configured to determine whether the mainframe system is connected to a physical graphic unit in a first boot procedure of the mainframe system;
wherein the EFI BIOS system is configured to execute the virtual graphic card driver in a DXE stage of the first boot procedure for mounting the virtual graphic card driver on the first memory when the CPU determines that the mainframe system is not connected to a physical graphic unit; and
wherein the CPU is configured to render the physical graphic unit to execute a physical graphic driver built-in in the physical graphic unit in the DXE stage of the first boot procedure for mounting the physical graphic driver on the first memory when the CPU determines that the mainframe system is connected to the physical graphic unit.

6. The mainframe system of claim 5, wherein the second memory is further configured to store an EFI boot loader for executing a second boot procedure of the EFI BIOS system.

7. The mainframe system of claim 5, wherein when the CPU is further configured to load the physical graphic driver from the physical graphic unit to the first memory when the CPU determines that the mainframe system is connected to the physical graphic unit, so that the mainframe system is capable of driving the physical graphic unit.

8. The mainframe system of claim 5, wherein the physical graphic unit is an EFI external graphic card.

9. The mainframe system of claim 8, wherein the EFI external graphic card comprises an EFI graphic card driving module which stores an EFI graphic card driver.

10. The mainframe system of claim 9, wherein the CPU is further configured to drive the EFI external graphic card when the CPU determines that the mainframe system is connected to the physical graphic unit, for mounting the EFI graphic card driver on the first memory.

11. The mainframe system of claim 5, wherein the connection port is a wired USB port, a wireless USB port, or an IP USB port.

12. The mainframe system of claim 5 wherein the EFI BIOS system is configured to select one of a plurality of physical graphic units and to render the selected physical graphic unit to execute the built-in physical graphic driver for mounting the physical graphic driver on the first memory when the CPU determines that the mainframe system is connected to the plurality of physical graphic units during the first boot procedure.

13. A booting method of an EFI BIOS system, comprising:
determining whether a mainframe system is connected to a physical graphic unit;
executing a virtual graphic card driver stored in the EFI BIOS system included by the mainframe system for mounting the virtual graphic card driver on a first memory of the mainframe system when the mainframe system is determined to not be connected to a physical graphic unit; and
driving the physical graphic unit for mounting a physical graphic driver stored in the physical graphic unit on the first memory when the mainframe system is determined to be connected to the physical graphic unit.

14. The method of claim 13, further comprising:
executing a boot security phase (SEC phase) of the mainframe system;
executing a pre-EFI initialization phase (PEI) of the mainframe system; and
executing a DXE of the mainframe system.

15. The method of claim 13, wherein driving the physical graphic unit for mounting a physical graphic driver stored in the physical graphic unit on the first memory when the mainframe system is determined to be connected to the physical graphic unit comprises:
loading a graphic driver of the physical graphic unit into the first memory when the mainframe system is determined to be connected to the physical graphic unit, for rendering the mainframe system to utilize the graphic driver for driving the physical graphic unit.

16. The method of claim 13, wherein the physical graphic unit is an EFI external graphic card.

17. The method of claim 16, wherein the EFI external graphic card comprises an EFI graphic card driving module which stores an EFI graphic card driver.

18. The method of claim 17, wherein driving the physical graphic unit for mounting a physical graphic driver stored in the physical graphic unit on the first memory when the mainframe system is determined to be connected to the physical graphic unit comprises:
driving the EFI external graphic card when the mainframe system is determined to be connected to the physical graphic unit, for mounting the EFI graphic card driver on the first memory.

19. The method of claim 16, wherein the EFI external graphic card utilizes a wired USB port, a wireless USB port, or an IP USB port.
